(19) United States
(12) Patent Application Publication
(10) Pub. No.: US 2011/0091841 A1
(43) Pub. Date: Apr. 21, 2011

(54) Diet dinnerware

(76) Inventors: Seymour Orlinsky, Boca Raton, FL (US); Ellen Orlinsky, Boca Raton, FL (US); David D. Spiegel, Stamford, CT (US); Sylvia C. Spiegel, Stamford, CT (US)

(21) Appl. No.: 11/546,199

(22) Filed: Oct. 11, 2006

Related U.S. Application Data
(60) Provisional application No. 60/727,114, filed on Oct. 14, 2005.

(51) Int. Cl. G09B 19/00; A47G 21/00

(52) U.S. Cl. 434/127; 30/123

(57) ABSTRACT

A dieting aid having an alternating timed red and green light. A spoon, fork, and table model have a push button and flashing or alternating red and green lights. A red light turns on or flashes for a first predetermined time, preferably twenty-five seconds indicating a time to rest without eating. After the red light, a green light goes on for forty seconds indicating a time to eat. The alternating red and green lights acts as a reminder to control and slow down eating, thereby controlling weight gain easily and simply.

### RELATED APPLICATION

This application claims the benefit of U.S. Provisional Application No. 60/727,114 filed Oct. 14, 2005.

### FILED OF THE INVENTION

The invention relates generally to a dieting aid and more specifically to a spoon, fork, and table model having a timing light started by a push of a button.

### BACKGROUND OF THE INVENTION

Dieting is hard work. It is hard because many of us really do love to eat. Some of us are compulsive eaters. The reasons are as many as the individual needs. All too often we eat too fast and don't give our bodies a chance to digest our food, we overeat and gain weight. Therefore, there is a need for anything that can help us change the habits that cause obesity and the many related health problems.

### SUMMARY OF THE INVENTION

The present invention comprises a spoon, fork, or table model device having batteries inside and a push button for turning a light on for a predetermined time. A red light flashes red for a first predetermined time, preferably 25 seconds, signaling a time to stop eating and put your fork or spoon down, then a light flashes green for a second predetermined time, preferably 40 seconds, signaling a time to eat.

It is an object of the present invention to provide a new and non invasive approach to dieting both at home and in restaurants.

It is another object of the present invention to make healthy eating habits a part of your well being.

It is yet another object of the present invention to provide self control of your body and eating pace providing a way to change bad habits.

It is an advantage of the present invention that by eating slower your body can actually feel full and keep you from overeating.

It is another advantage of the present invention that it enhances the digestion of food for your body by making you aware of your bad eating habits.

It is a feature of the present invention that a flashing red light and a flashing green light are used as a reminder to stop eating and put our dinnerware down.

These and other objects, advantages, and features will become more readily apparent in view of the following detailed description.

### BRIEF DESCRIPTION OF THE DRAWINGS

FIG. 1 is a perspective view of a spoon embodiment of the present invention.

FIG. 2 is a perspective view of a fork embodiment of the present invention.

FIG. 3 is a perspective view of a table model embodiment of the present invention.

### DETAILED DESCRIPTION OF THE PREFERRED EMBODIMENTS

The invention and product comes as a package which includes a spoon, fork, and table model to take to restaurants. The invention comprises a spoon or fork handle with batteries inside. By a push of a button a flashing or intermittent light is started. The light turns on back and forth between green and red. The light starts at the press of the button.

When the light turns green it is time to eat. The light turns green for approximately forty seconds. This is more than enough time to begin to digest your food. After forty seconds the light turns red. When the light is red it is time to put your fork down. The table model does the same thing. This prevents attention being drawn to you while dinning out.

The timing or duration of the intermittent or flashing light colors can be reasonably adjusted.

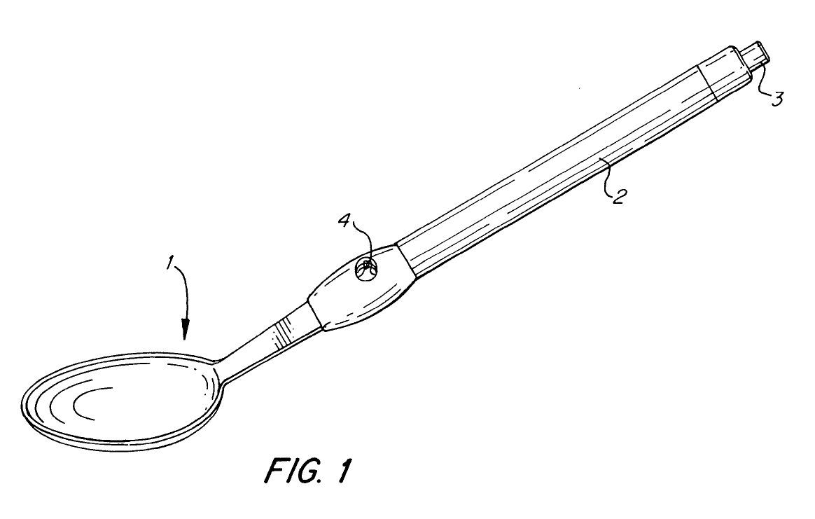

FIG. 1 illustrates a spoon embodiment of the present invention. In FIG. 1 spoon 1 has a handle 2 with batteries inside. The handle 2 has a push button 3 for starting a flashing or solid red and green alternating light 4. The timing of the light can vary.

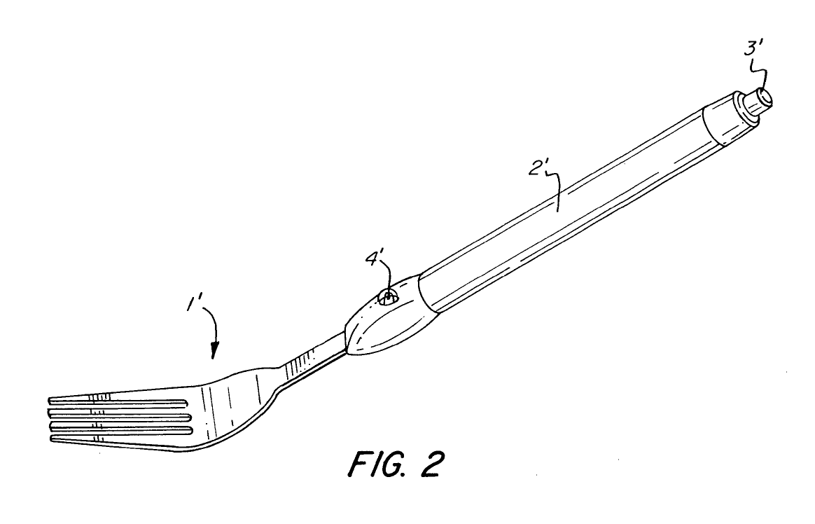

FIG. 2 illustrates a fork embodiment of the present invention. In FIG. 2 a fork 1′ has a handle 2′ with batteries inside. The handle 2′ has a push button 3′ for starting a flashing or solid red and green alternating light 4′. The timing of the light can vary.

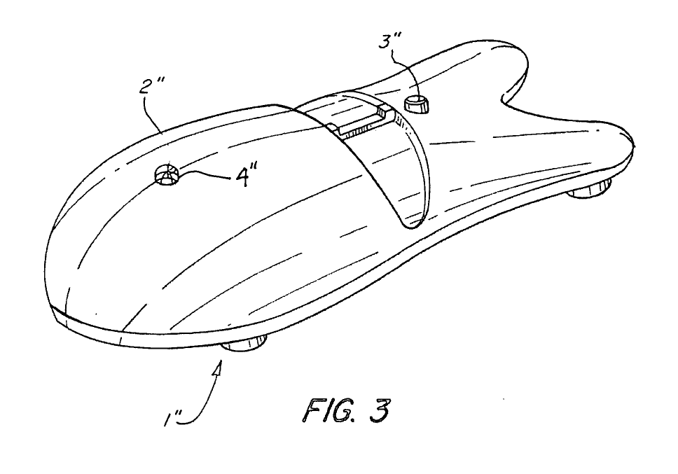

FIG. 3 illustrates a table model embodiment of the present invention. In FIG. 3 the table model 1″ has a body 2″ with batteries inside. The body 2″ has a push button 3″ for starting a flashing or solid alternating red and green light with a timing sequence that can vary.

The present invention provides a revolutionary weight control device that can help change eating habits and result in the loss of weight naturally and without any drugs. The diet fork, diet spoon, and diet table model will help pace eating and control weight. The present invention prevents individuals from eating too fast without giving their bodies a chance to digest food resulting in overeating and gaining weight. The present invention by using timed, alternating red and green lights is a simple solution for those of us who cannot put their fork or spoon down. After pressing the button, for twenty-five seconds the light will flash red indicating time to put your fork down and rest. Then the green light goes on for forty seconds indicating time to eat. With the diet dinnerware of the present invention your meal will be more fun.

While the present invention has been described with respect to several different embodiments, it will be obvious that various modifications may be made without departing from the spirit and scope of this invention.

What is claimed is:

1-5. (canceled)

6. A dieting aid comprising:
a body containing batteries;
a first light having a first color;
a second light having a second color, the second color being different than the first color; and
a button coupled to said first and second light, wherein said button activates said first light for a first predetermined time and said second light for a second predetermined time,
whereby the first predetermined time indicates a time to rest and stop eating and the second predetermined time indicates a time to eat.

7. A dieting aid as in claim 6 wherein:
said body is in the form of a spoon.

8. A dieting aid as in claim 6 wherein:
said body is in the form of a fork.

9. A dieting aid as in claim 6 wherein:
the first color is red and the second color is green.

10. A dieting aid as in claim 6 wherein:
the first predetermined time is less than the second predetermined time.

11. A dieting aid as in claim 6 wherein:
the first predetermined time is approximately twenty-five seconds and the second predetermined time is approximately forty seconds.

12. A dieting aid dinnerware package comprising:
a fork having a body portion and a light on the body portion, the light being activated by a push button and having an alternating illuminated first color for a first predetermined time and an illuminated second color for a second predetermined time;
a spoon having a body portion and a light on the body portion, the light being activated by a push button and having an alternating illuminated first color for a first predetermined time and an illuminated second color for a second predetermined time; and
a table model having a body portion and a light on the body portion, the light being activated by a push button and having an alternating illuminated first color for a first predetermined time and an illuminated second color for a second predetermined time,
whereby for said fork, spoon, or table model the first predetermined time indicates a time to rest and stop eating and the second predetermined time indicates a time to eat.

13. A dieting aid dinnerware package as in claim 12 wherein:
for said fork, spoon, and table model the first color is red and the second color is green.

14. A dieting aid dinnerware package as in claim 12 wherein:
for said fork, spoon, and table model the first predetermined time is less than the second predetermined time.

15. A dieting aid dinnerware package as in claim 12 wherein:
for said fork, spoon, and table model the first predetermined time is approximately twenty-five seconds and the second predetermined time is approximately forty seconds.

16. A method of controlling eating comprising the steps of:
providing a timing device having a first signal and second signal;
turning the first signal on for a first predetermined time as an indication of when to stop eating; and
turning the second signal on after the first predetermined time for a second predetermined time as an indication of when to continue eating,
whereby a reminder is provided aiding dieting and loss of weight.

17. A method of controlling eating as in claim 16 wherein:
the timing device in the form of a spoon.

18. A method of controlling eating as in claim 16 wherein:
the timing device in the form of a fork.

19. A method of controlling eating as in claim 16 wherein:
first signal comprises a red light and the second signal comprises a green light.

20. A method of controlling eating as in claim 16 wherein:
the first predetermined time is less than the second predetermined time.

21. A method of controlling eating as in claim 16 wherein:
the first predetermined time is approximately twenty-five seconds and the second predetermined time is approximately forty seconds.
